(19) United States
(12) Patent Application Publication
(10) Pub. No.: US 2017/0368752 A1
(43) Pub. Date: Dec. 28, 2017

(54) NON-CONTACT CONTROL OF LAYERING FOR THREE-DIMENSIONAL OBJECT PRINTING

(71) Applicant: Xerox Corporation, Norwalk, CT (US)

(72) Inventors: Timothy G. Shelhart, West Henrietta, NY (US); Aaron M. Moore, Fairport, NY (US); Ron E. Dufort, Rochester, NY (US); Timothy D. Slattery, Elma, NY (US)

(21) Appl. No.: 15/193,303

(22) Filed: Jun. 27, 2016

(51) Int. Cl. B29C 64/386; B33Y 50/02; B33Y 10/00; B33Y 30/00; B29C 64/40; B29C 64/112

(52) U.S. Cl. CPC B29C 64/386; B29C 64/40; B29C 64/112; B33Y 10/00; B33Y 30/00; B33Y 50/02

(57) ABSTRACT

A three-dimensional object printer comprises a platen, an ejector head having a plurality of ejectors configured to eject drops of material toward the platen, a sensor configured to measure heights of drops of material ejected onto the platen, and a controller operatively connected to the sensor and the ejector head. The controller is configured to operate the plurality of ejectors to eject drops of material toward the platen to form a first layer of material upon the platen; operate the sensor to measure a height profile of the first layer of material; and operate the plurality of ejectors to eject drops of material toward the platen to form a second layer of material upon the first layer of material with reference to the measured height profile.

### TECHNICAL FIELD

The device and method disclosed in this document relates to three-dimensional object printing and, more particularly, to leveling systems in three-dimensional object printers.

### BACKGROUND

Digital three-dimensional object manufacturing, also known as digital additive manufacturing, is a process of making a three-dimensional solid object of virtually any shape from a digital model. Three-dimensional object printing is an additive process in which one or more ejector heads deposit material to build up a part. Material is typically deposited in discrete quantities in a controlled manner to form layers which collectively form the part. The initial layer of material is deposited onto a substrate, and subsequent layers are deposited on top of previous layers. The substrate is supported on a platform that can be moved relative to the ejection heads so each layer can be printed; either the substrate is moved via operation of actuators operatively connected to the platform, or the ejector heads are moved via operation of actuators operatively connected to the ejector heads. Three-dimensional object printing is distinguishable from traditional object-forming techniques, which mostly rely on the removal of material from a work piece by a subtractive process, such as cutting or drilling.

In many three-dimensional object printing systems, a partially printed part is subjected to a leveling process after each layer of material is deposited. The leveling process ensures that each layer is a controlled thickness, and that the subsequent layer has a flat surface to be formed upon. By performing this leveling process between each successive layer, higher quality parts are manufactured within narrower tolerances.

In some three-dimensional object printing systems, a leveling roller flattens the upper surface of the part after each successive layer of material is deposited. FIG. 6 shows a prior art three-dimensional object printing system 10 having a conveyor 14 and a leveling roller 18. The conveyor 14 has a substantially planar surface 22 upon which printed parts, such as the partially formed part 26, are built. The conveyor 14 is configured to convey the part 26 in a conveying direction X that is parallel to the surface 22 of the conveyor 14. The roller 18 is arranged above the surface 22 of the conveyor 14 in a vertical direction Y that is normal to the surface 22 of the conveyor 14. The roller 18 is cylindrical about a longitudinal axis that extends in a lateral direction Z, which is parallel to the surface 22 of the conveyor 14 and orthogonal to the conveying direction X.

After each successive layer of material is deposited, the conveyor 14 conveys the part 26 in the conveying direction X. The roller 18 is adjusted to an appropriate distance from the surface 22 of the conveyor 14. The conveyor 14 feeds the part 26 between the conveyor 14 and the roller 18 to flatten an upper surface 30 of the part 26 that is opposite a bottom surface of the part 26 that sits upon the surface 22 of the conveyor 14.

The printing system 10 is designed to handle parts, such as the part 26, up to 20 inches wide in the lateral direction Z, but the roller 18 is intended to only remove about 3 microns of material from the upper surface 30 of the part 26. This constraint imposes costly manufacturing tolerances for the roller 18. For example, the roller 18 can be twenty inches long and two inches in diameter. This relatively large roller must be manufactured with tight tolerances for cylindricity. Particularly, the roller must be manufactured with tight tolerances for straightness and roundness. As used herein “straightness” refers to the variability of the roller's diameter across its length. As used herein “roundness” refers to the variability in diameter that depends on the angle on the circumference at which the diameter measured. A roller with perfect roundness has precisely the same diameter when measured from all angles. Conversely, a roller having imperfect roundness has variances in diameter that depend on the angle at which it is measured. This variance in diameter at different angles is referred to as “run-out.”

FIG. 7 shows a side view of the printing system 10 with a roller 18 having imperfect roundness, or run-out. A circular outline 34 shows an ideal roundness of the roller 18. As can be seen, portions of the roller 18 extend beyond the circular outline 34. The particular run-out of the roller 18 varies with each roller that is manufactured. Accordingly, the roller 18 is incapable of truly flattening the upper surface 30 of the part 26 unless the run-out of the roller is eliminated, but significant manufacturing costs must be incurred for the elimination of the run-out.

FIG. 8A and FIG. 8B show the effect of the run-out of the roller 18 on the leveling process. As the roller 18 moves over the upper surface 30 of the part 26, the longitudinal axis of the roller 18 maintains a fixed distance from the conveyor 14. However, because the diameter of the roller 18 varies, a ripple is produced in the upper surface 30 of the part 26 as the roller 18 moves across the part 26, as seen in FIG. 8B. Accordingly, the run-out of the roller 18 adversely impacts the leveling process.

In current printing systems, such as the printing system 10, the rollers 18 are ground to very tight tolerances on the order of one micron to minimize the effect of the run-out, which comes at great expense. Even when manufactured to the required precision, the rollers 18 risk contaminating or damaging the part 26. Additionally, with each pass of the roller 18, material is removed away from the part 26 and wasted. What is needed is a low cost method for leveling substrates in three-dimensional object printing.

### SUMMARY

A three-dimensional object printer includes a platen; an ejector head having a plurality of ejectors configured to eject drops of material toward the platen; a sensor configured to measure heights of drops of material ejected onto the platen; and a controller operatively connected to the sensor and the ejector head. The controller is configured to operate the plurality of ejectors to eject drops of material toward the platen to form a first layer of material upon the platen; operate the sensor to measure a height profile of the first layer of material; and operate the plurality of ejectors to eject drops of material toward the platen to form a second layer of material upon the first layer of material with reference to the measured height profile.

A method of operating a three-dimensional object printer includes operating a plurality of ejectors of an ejector head to eject drops of material toward a platen to form a first layer of material upon the platen; operating a sensor to measure a height profile of the first layer of material; and operating the plurality of ejectors to eject drops of material toward the platen to form a second layer of material upon the first layer of material with reference to the measured height profile.

### BRIEF DESCRIPTION OF THE DRAWINGS

The foregoing aspects and other features of the method and device are explained in the following description, taken in connection with the accompanying drawings.

FIG. 1 shows a three-dimensional object printer.

FIG. 2 shows a flow diagram for a method of operating a three-dimensional object printer.

FIGS. 3A-D illustrate performance of the steps of the method of FIG. 2 using the printer of FIG. 1.

FIG. 4 shows a plot including an exemplary measured height profile and an exemplary target height profile.

FIG. 5 shows an exemplary control system diagram for the printer of FIG. 1.

FIG. 6 shows perspective view of a prior art three-dimensional object printing system.

FIG. 7 shows a side view of the prior art printing system of FIG. 6.

FIGS. 8A and 8B depict the ripple effect caused by run-out in the roller of the leveling assembly in the prior art printing system of FIG. 6.

### DETAILED DESCRIPTION

For a general understanding of the environment for the printer and method disclosed herein as well as the details for the printer and method, reference is made to the drawings. In the drawings, like reference numerals designate like elements.

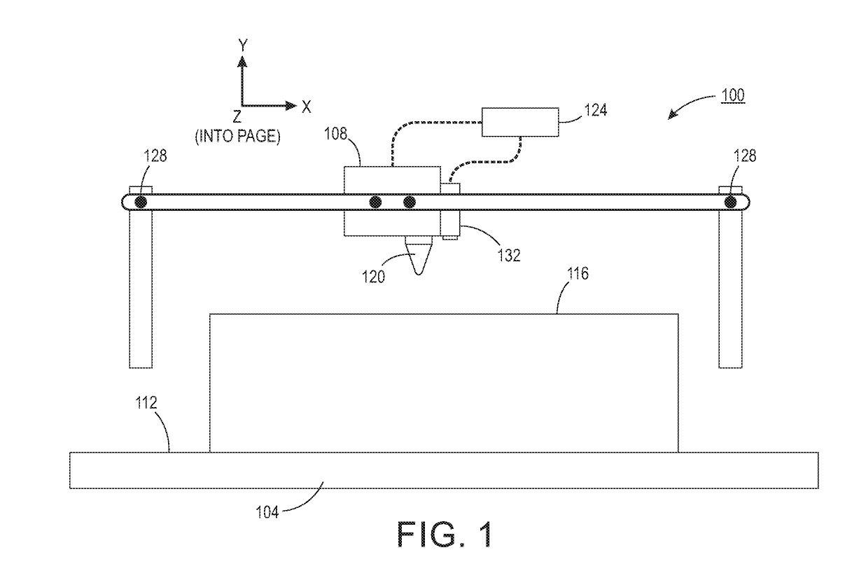

FIG. 1 shows a three-dimensional object printer 100. The printer 100 includes a platen 104 and an ejector head 108. The platen 104 has substantial planar upper surface 112 upon which three-dimensional objects, such as the part 116, are formed by the printer 100. The ejector head 108 has a plurality of ejectors 120 configured to eject drops of a build material to form three-dimensional objects upon the surface 112 of platen 104. In many embodiments, the plurality of ejectors 120 are arranged in one or more rows in the cross-process direction Z. However, in other embodiments, the plurality of ejectors 120 may instead comprises only a single ejector 120. In some embodiments, the plurality of ejectors includes a first plurality of ejectors configured to eject drops of a build material and a second plurality of ejectors configured to eject drops of a support material, such as wax.

The printer 100 includes a controller 124 operatively connected to the ejector head 108. The controller 124 is configured to operate the ejector head 108 with reference to image data to form a three-dimensional object on surface 112 that corresponds to the image data. To form each layer of the three-dimensional object, the controller 124 operates the printer 100 to sweep the ejector head 108 one or more times in the process direction X, while ejecting drops of material onto the platen 104 from the ejectors 120. In the case of multiple passes, the ejector head 108 shifts in the cross-process direction Z between each sweep. After each layer is formed, the ejector head 108 moves away from the platen 104 in the vertical direction Y to begin printing the next layer. The printer 100 may include rails 128 or other actuators known in the art configured to facilitate the aforementioned movements of the ejector head 108 in the X, Y, and Z directions. In alternative embodiments, the printer 100 includes actuators (not shown) configured to move the platen 104 in the X, Y, and Z directions to accomplish the same relative movements of the ejector head 108 and the platen 104.

The printer 100 further includes a sensor 132 operatively connected to the controller 124 and configured to sense heights of the layers of material formed by the printer 100. As discussed in greater detail below, the controller 124 is configured to operate the sensor 132 to measure a height profile of an upper surface of a layer of a partially formed part 116. Based on this height profile, variances or errors in the height profile of the layer can be compensated by adjusting the thickness profile of the subsequent layer. In one embodiment, the sensor 132 is an optical profilometer configured to move with respect to the platen 104 in the process direction X to scan an entire part 116, one line or row at a time. However, other configurations are possible in which the sensor 132 does not need to move to scan the part 116. Additionally, as shown, the sensor 132 is attached to the ejector head 108. However, the sensor 132 can be configured for movement independent of the ejector head 108 and is not attached to the ejector head 108 in such a configuration.

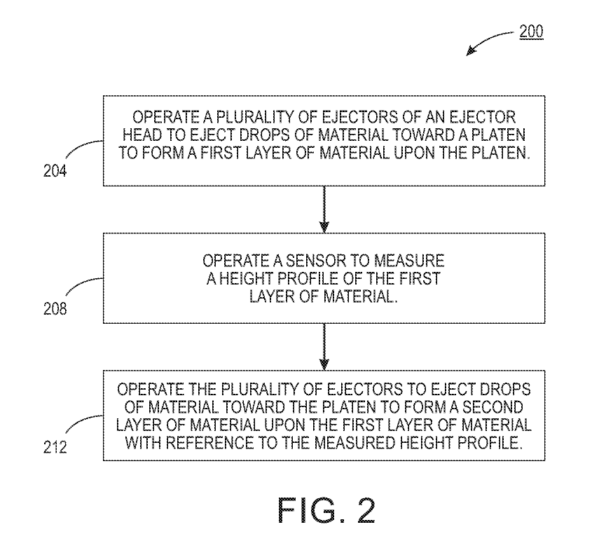

A method 200 for operating a three-dimensional object printer is shown in FIG. 2. In the description of the method, statements that the method is performing some task or function refers to a controller or general purpose processor executing programmed instructions stored in non-transitory computer readable storage media operatively connected to the controller or processor to manipulate data or to operate one or more components in the printer to perform the task or function. The controller 124 noted above can be such a controller or processor. Alternatively, the controller can be implemented with more than one processor and associated circuitry and components, each of which is configured to form one or more tasks or functions described herein.

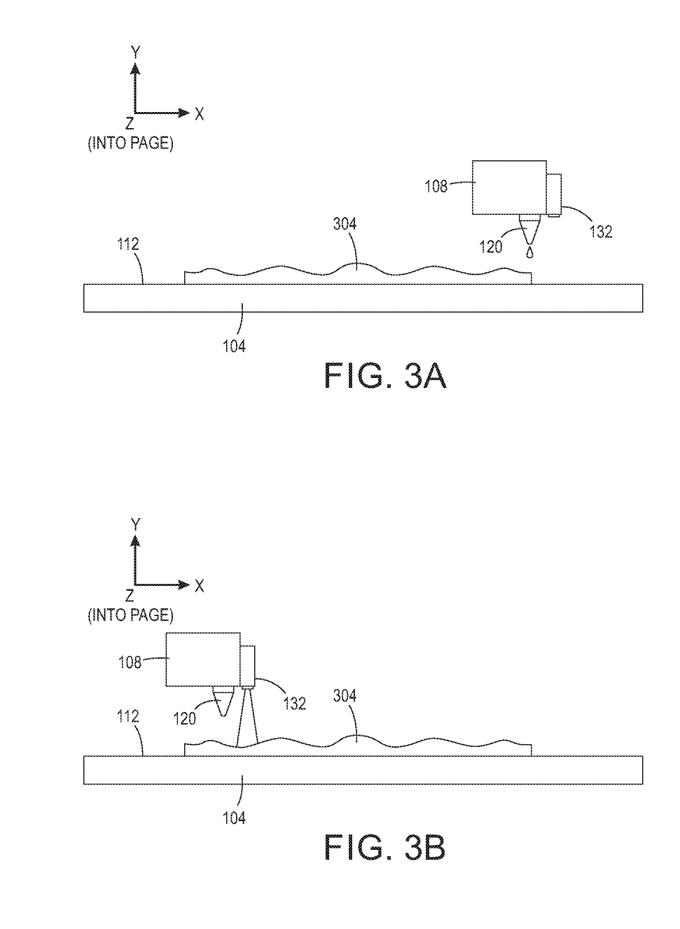

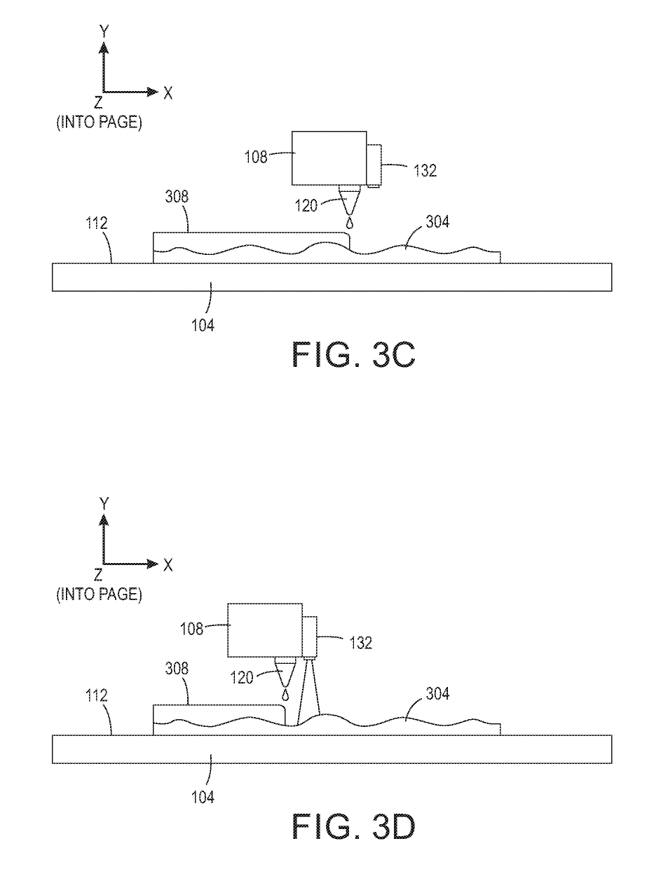

When the method 200 is performed, it begins by operating a plurality of ejectors of an ejector head to eject drops of material toward a platen to form a first layer of material upon the platen (block 204). Particularly, as shown in FIG. 3A, the controller 124 is configured to operate the ejectors 120 of ejector head 108 to sweep one or more times in the process direction X, while ejecting drops of material toward the platen 104 from the ejectors 120 to form a first layer of material 304 upon the surface 112 of the platen 104. As shown, the first layer 304 is formed directly upon the platen 104, but may similarly be a layer of material formed upon a previously formed layer of material on the platen 104.

Next, the method 200 continues by operating a sensor to measure a height profile of the first layer of material (block 208). Particularly, as shown in FIG. 3B, the controller 124 is configured to operate the sensor 132 to measure a height profile of the partially formed part 116 after formation of the first layer of material 304. In one embodiment, the sensor 132 sweeps in the process direction X one or more times to scan the first layer 304 entirely. However, in some embodiments, the sensor 132 is configured to scan the entire first layer 304 without moving. As used herein, the term “height profile” refers to a plurality of height values or distance values that are associated with a plurality of relative positions in space and which represent the contours of the surface of a partially formed part. In one particular embodiment, the “height profile” represents the height of the partially formed part as a function of a position in the process direction X and a position in the cross-process direction Z, e.g. height=f(x,z).

Next, the method 200 continues by operating the plurality of ejectors to eject drops of material toward the platen to form a second layer of material upon the first layer of material with reference to the measured height profile (block 212). Particularly, as shown in FIG. 3C, the controller 124 is configured to operate the ejectors 120 of ejector head 108 to sweep one or more times in the process direction X, while ejecting drops of material toward the platen 104 from the ejectors 120 to form a second layer of material 308 atop the first layer of material 304. The controller 124 is configured to operate the ejectors 120 so as to form the second layer of material 308 such that it has a thickness profile that compensates for variances in the measured height profile after the formation of the first layer of material 304. As used herein, the term “thickness profile” refers to a plurality of thickness values or length values that are associated with a plurality of relative positions in space. In one particular embodiment, the “thickness profile” represents the thickness of a layer of material as a function of a position in the process direction X and a position in the cross-process direction Z, e.g. thickness=f(x,z).

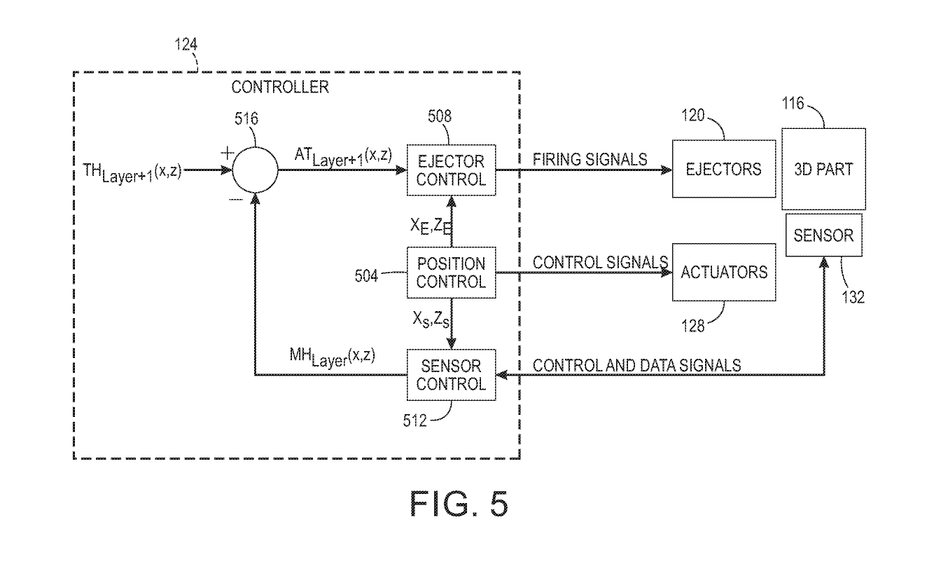

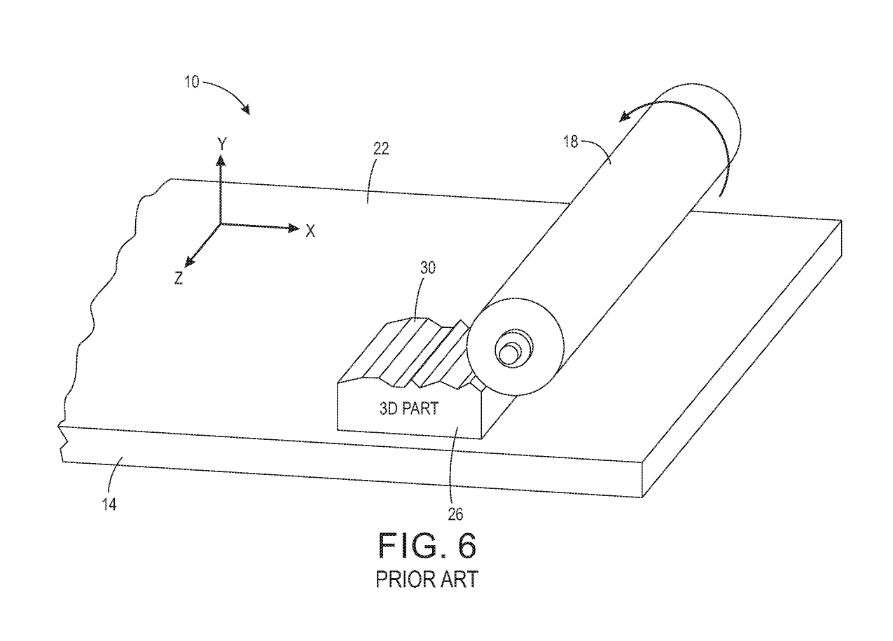

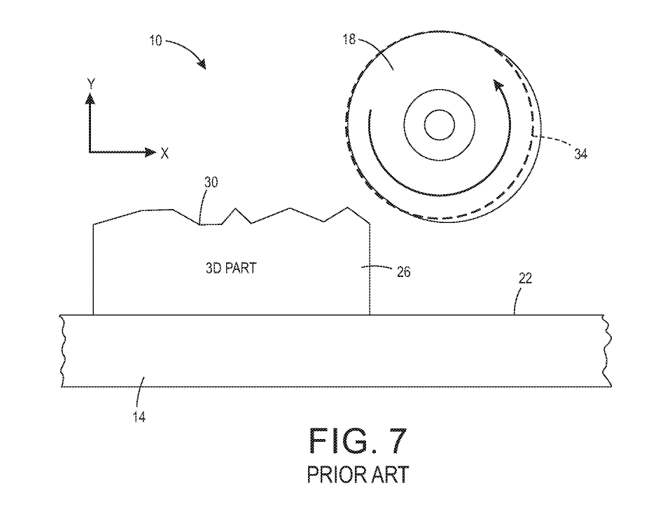

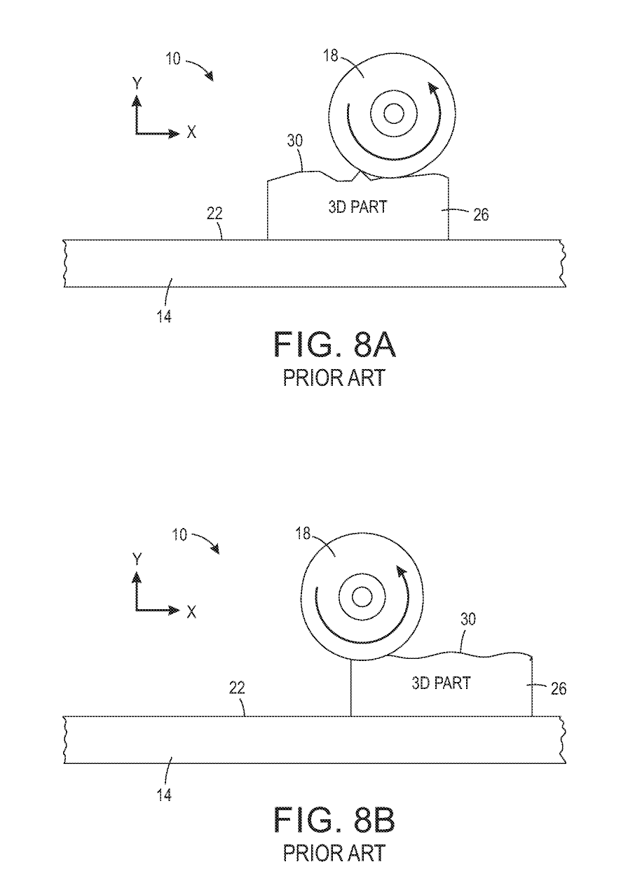

As described in greater detail below with respect to FIG. 5, in one embodiment, an adjusted thickness profile for the second layer of material 308 is determined based at least on the measured height profile of part after formation of the first layer of material 304. The adjusted thickness profile is used to adjust the relative drop volumes or drop masses of the drops of material that are ejected to form the second layer of material 308 such that the second layer of material 308 has variations in thickness that compensate for measured variations in height after formation of the first layer of material 304.

In one embodiment of the method 200, the processing of blocks 208 and 212 are performed substantially simultaneously. Particularly, as shown in FIG. 3D, the controller 124 is configured to, while operating the sensor 132 to measure the height profile, determine the adjusted thickness profile in real time and operate the ejectors 120 to form the second layer of material 308 according to the adjusted thickness profile. As shown in FIG. 3D, the sensor 132 is physically arranged ahead of the ejectors 120 in the process direction X such that each portion of the second layer of material 308 is formed after the sensor 132 has scanned the height of the corresponding portion of the first layer of material 304. In a further embodiment, the sensor 132 comprises a pair of sensors (not shown) arranged on opposite sides of the ejectors 120 in the process direction X. In this way, the printer 100 can operate bi-directionally in the process direction X, thereby enabling printing speed efficiencies.

In many embodiments, the method 200 is repeated for each layer of the part until the part is completely formed. Particularly, the controller 124 is configured to operate the ejectors 120 of the ejector head 108 to form a plurality of layers on the platen 104. After forming each successive layer, the controller 124 is configured to operate the sensor 132 to measure a height profile of the previously formed layer of material. In forming each successive layer, the controller 124 is configured to operate the ejectors 120 with reference to the previously measured height profile in order to compensate for unintended variances in the height profile of the previously formed layer.

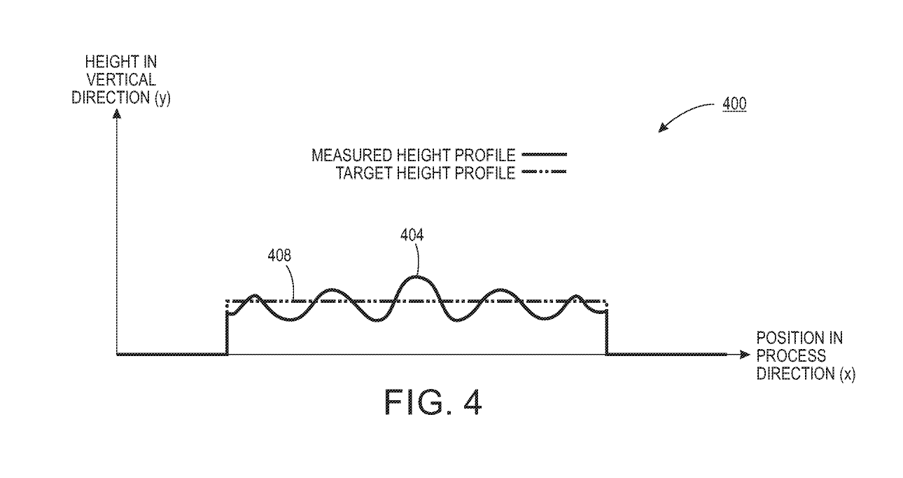

For the purpose of furthering the understanding of how the adjusted thickness profile is determined, an exemplary measured height profile is shown in FIG. 4. Particularly, FIG. 4 shows a plot 400 including an exemplary measured height profile 404. The measure height profile 404 is indicated by the solid line and corresponds to the measured height of part after the formation of the first layer of material 304. The plot 400 also includes a target height profile 408. The target height profile 408 is indicated by the dotted line and corresponds to an ideal or intended height of the part after the formation of the first layer of material 304.We note that, for simplicity, the plot 400 only shows the profiles 404 and 408 with respect to a position (x) in the process direction X. However, in practice a height profile would include values defined with respect to both a position in the process direction X and a position in the cross-process direction Z. Additionally, as shown, a zero height value in the vertical direction Y essentially corresponds to the surface 112 of the platen. However, this correspondence is merely arbitrary for the purpose of the plot 400.

FIG. 5 shows a control system diagram for one embodiment of the printer 100. The control system is, in essence, a closed-loop feedback system that uses the sensor 132 to determine an error, for which the system compensates in a closed-loop manner by adjusting a thickness profile of a subsequent layer. In the illustrated embodiment, the controller 124 includes a position control component 504, an ejector control component 508, and a sensor control component 512. We note that the particular arrangement shown and described with respect to FIG. 5 is merely exemplary. One of ordinary skill in the art would understand that many alternative and equivalent arrangements could be employed to achieve similar functions.

The position control component 504 is configured to provide control signals for operating the rails 128 or other actuators responsible for providing relative motion of the ejectors 120 and the platen 104 and for providing relative motion of the sensor 132 and the platen 104, as required. Additionally, in one embodiment, the position control component 504 provides relevant position information to the ejector control component 508 and the sensor control component 512. In particular, the position control component 508 provides position information (X_{E}, Z_{E}) to the ejector control component 508, which indicates a position of the ejectors 120 in the process direction X and in the cross-process direction Z. The position control component 508 also provides position information (X_{S}, Z_{S}) to the sensor control component 512, which indicates a position of the sensor 132 in the process direction X and in the cross-process direction Z.

The sensor control component 512 is configured to operate the sensor 132 to measure heights of portions of the partially formed part 116. The sensor control component 512 is configured to receive signals from the sensor 132 that correspond to a height of the partially formed part 116 at a particular position. The sensor control component 512 is also configured to receive the position information (X_{S}, Z_{S}) regarding the position of the sensor 132 from the position control component 504. Based on the signals from the sensor 132 and the position information (X_{S}, Z_{S}), the sensor control component 512 is configured to generate a measured height profile for the partially formed part after formation of a layer of material, indicated as MH_{Layer}(x,z) in FIG. 5.

The controller 124 is configured to compare the measured height profile MH_{Layer}(x,z) with a target height profile for the next layer to be formed, indicated as TH_{Layer}(x,z,) in FIG. 5. Based on the comparison, the controller 124 is configured to determine an adjusted thickness profile for the next layer to be formed, indicated as AT_{Layer+1}(x,z) in FIG. 5. In one embodiment, the controller 124 includes a comparator 516 configured to subtract the measured height profile MH_{Layer}(x,z) from the target height profile TH_{Layer+1}(x,z,) in order to calculate the adjusted thickness profile AT_{Layer+1}(x,z).

As would be understood by a person having ordinary skill in the art, the particular mathematics can be expressed in many alternative but equivalent forms. For example, the target height profile for the next layer to be formed can also be represented as a summation of a target profile for the previously formed layer with a nominal thickness profile for the next layer to be formed. Additionally, a height error profile for the previously formed layer can be determined by comparing the measured height profile for the previously formed layer with the target profile for the previously formed layer. The adjusted thickness profile for the next layer to be formed can then be determined by modifying the nominal thickness profile for the next layer to be formed with the height error profile for the previously formed layer.

The ejector control component 508 is configured to receive the adjusted thickness profile AT_{Layer+1}(x,z) from the comparator 516. Additionally, the ejector control component 508 is configured to receive the position information (X_{E}, Z_{E}) regarding the position of the ejectors 120 from the position control component 504. Based on the adjusted thickness profile AT_{Layer+1}(x,z) and the position information (X_{E}, Z_{E}), the ejector control component 508 is configured to provide appropriate firing signals to the ejectors 120. Particularly, the ejector control component 508 is configured to calculate a required drop mass or drop volume that should be ejected at a current position of the ejectors 120 in order to achieve a thickness according to the adjusted thickness profile AT_{Layer+1}(x,z). Based on the calculated drop mass or drop volume, the ejector control component 508 is configured to provide firing signals to the ejectors 120 that achieve the calculated drop mass or drop volume. In this way, the ejector control component 508 operates the ejectors 120 to form a subsequent layer with a thickness profile that compensates for the variations in height of the previously formed layer.

It will be appreciated that variants of the above-disclosed and other features and functions, or alternatives thereof, may be desirably combined into many other different systems, applications or methods. Various presently unforeseen or unanticipated alternatives, modifications, variations, or improvements therein may be subsequently made by those skilled in the art, which are also intended to be encompassed by the following claims.

What is claimed is:

1. A three-dimensional object printer comprising:
a platen;
an ejector head having a plurality of ejectors configured to eject drops of material toward the platen;
a sensor configured to measure heights of drops of material ejected onto the platen; and
a controller operatively connected to the sensor and the ejector head, the controller being configured to:
operate the plurality of ejectors to eject drops of material toward the platen to form a first layer of material upon the platen;
operate the sensor to measure a height profile of the first layer of material; and
operate the plurality of ejectors to eject drops of material toward the platen to form a second layer of material upon the first layer of material with reference to the measured height profile.

2. The printer according to claim 1, the controller being configured to:
operate the plurality of ejectors to eject the drops of material toward the platen to form the second layer of material with further reference to a target height profile.

3. The printer according to claim 1, wherein the controller is configured to concurrently operate the sensor to measure the height profile and operate the plurality of ejectors to form the second layer of material.

4. The printer according to claim 1, the controller being configured to:
compare the measured height profile with a target height profile; and
operate the plurality of ejectors to eject the drops of material toward the platen to form the second layer of material with reference to the comparison of the measured height profile with a target height profile.

5. The printer according to claim 1, the controller being configured to:
calculate differences between the measured height profile with a target height profile; and
operate the plurality of ejectors to eject the drops of material toward the platen to form the second layer of material with reference to the calculated differences between the measured height profile with a target height profile.

6. The printer according to claim 1, the controller being configured to:
calculate differences between the measured height profile with a target height profile;
calculate relative drop volumes of the drops of material to be ejected toward the platen to form the second layer of material based on the calculated differences between the measured height profile with a target height profile; and
operate the plurality of ejectors to eject the drops of material toward the platen to form the second layer of material with reference to calculated relative drop volumes.

7. The printer according to claim 1, the controller being configured to:
operate the plurality of ejectors to eject drops of material toward the platen to form a plurality of layers of material upon the platen; and
operate, after forming each successive layer of the plurality of layers, the sensor to measure a height profile of a previously formed layer of the plurality of layers, the operation of the plurality of ejectors to form each successive layer of the plurality of layers being performed with reference to the height profile of the previously formed layer.

8. The printer according to claim 1, wherein the sensor is an optical profilometer.

9. A method of operating a three-dimensional object printer, the method comprising:
operating a plurality of ejectors of an ejector head to eject drops of material toward a platen to form a first layer of material upon the platen;
operating a sensor to measure a height profile of the first layer of material; and
operating the plurality of ejectors to eject drops of material toward the platen to form a second layer of material upon the first layer of material with reference to the measured height profile.

10. The method according to claim 9, the operating of the plurality of ejectors to form the second layer comprising:
operating the plurality of ejectors to eject the drops of material toward the platen to form the second layer of material with further reference to a target height profile.

11. The method according to claim 9, wherein the operating of the sensor to measure the height profile and operating of the plurality of ejectors to form the second layer of material are performed concurrently.

12. The method according to claim 9 further comprising:
comparing the measured height profile with a target height profile; and
the operation of the plurality of ejectors to form the second layer is performed with reference to the comparison of the measured height profile with a target height profile.

13. The method according to claim 9 further comprising:
calculating differences between the measured height profile with a target height profile, the operation of the plurality of ejectors to form the second layer being performed with reference to the calculated differences between the measured height profile with a target height profile.

14. The method according to claim 9 further comprising:
calculating differences between the measured height profile with a target height profile; and
calculating relative drop volumes of the drops of material to be ejected toward the platen to form the second layer of material based on the calculated differences between the measured height profile with a target height profile, the operation of the plurality of ejectors to form the second layer is performed with reference to the calculated relative drop volumes.

15. The method according to claim 9, the controller being configured to:
operating the plurality of ejectors to eject drops of material toward the platen to form a plurality of layers of material upon the platen; and
operating, after forming each successive layer of the plurality of layers, the sensor to measure a height profile of a previously formed layer of the plurality of layers, the operation of the plurality of ejectors to form each successive layer of the plurality of layers being performed with reference to the height profile of the previously formed layer.
